(19) United States
(12) Patent Application Publication
(10) Pub. No.: US 2006/0147616 A1
(43) Pub. Date: Jul. 6, 2006

(54) Polymer catalyst for photovoltaic cell

(76) Inventors: Russell Gaudiana, Merrimack, NH (US); Jin-An He, N. Chelmsford, MA (US); David Waller, Lexington, MA (US)

Correspondence Address: Attn: Regina Passeri;Konarka Technologies, Inc., Suite 12, 116 John Street, Lowell, MA, 01852, US

(21) Appl. No.: 11/302,634

(22) Filed: Dec. 14, 2005

Related U.S. Application Data
(60) Provisional application No. 60/637,844, filed on Dec. 20, 2004.

(51) Int. Cl. B05D 5/12

(52) U.S. Cl. 427/74; 136/252

(57) ABSTRACT

Polymer catalysts for photovoltaic cells, as well as related compositions and methods, are disclosed.

### CROSS REFERENCE TO RELATED APPLICATION

Pursuant to 35 USC § 119(e), this application claims priority to U.S. Provisional Application Ser. No. 60/637,844, filed Dec. 20, 2004, the contents of which are incorporated herein by reference.

### TECHNICAL FIELD

This invention relates to polymer catalysts for photovoltaic cells, as well as related compositions, articles, and methods.

### BACKGROUND

Photovoltaic cells, sometimes called solar cells, can convert light, such as sunlight, into electrical energy. One type of photovoltaic cell is a dye-sensitized solar cell (DSSC).

Referring to FIG. 1, a DSSC 100 includes a charge carrier layer 140 (e.g., including an electrolyte, such as an iodide/iodine solution) and a photosensitized layer 145 (e.g., including a semiconductor material, such as TiO₂ particles) disposed between an electrode 101 and a counter electrode 111. Photosensitized layer 145 also includes a photosensitizing agent, such as a dye. In general, the photosensitizing agent is capable of absorbing photons within a wavelength range of operation (e.g., within the solar spectrum). Electrode 101 includes a substrate 160 (e.g., a glass or polymer substrate) and an electrically conductive layer 150 (e.g., an ITO layer or tin oxide layer) disposed on an inner surface 162 of substrate 160. Counter electrode 111 includes a substrate 110, an electrically conductive layer 120 (e.g., ITO layer or tin oxide layer), and a platinum layer 130, which catalyzes a redox reaction in charge carrier layer 140. Electrically conductive layer 120 is disposed on an inner surface 112 of substrate 110, while catalyst layer 130 is disposed on a surface 122 of electrically conductive layer 120. Electrode 101 and counter electrode 111 are connected by wires across an external electrical load 170.

During operation, in response to illumination by radiation in the solar spectrum, DSSC 100 undergoes cycles of excitation, oxidation, and reduction that produce a flow of electrons across load 170. Incident light excites photosensitizing agent molecules in photosensitized layer 145. The photoexcited photosensitizing agent molecules then inject electrons into the conduction band of the semiconductor in layer 145, which leaves the photosensitizing agent molecules oxidized. The injected electrons flow through the semiconductor material, to electrically conductive layer 150, then to external load 170. After flowing through external load 170, the electrons flow to layer 120, then to layer 130 and subsequently to layer 140, where the electrons reduce the electrolyte material in charge carrier layer 140 at catalyst layer 130. The reduced electrolyte can then reduce the oxidized photosensitizing agent molecules back to their neutral state. The electrolyte in layer 140 can act as a redox mediator to control the flow of electrons from counter electrode 111 to working electrode 101. This cycle of excitation, oxidation, and reduction is repeated to provide continuous electrical energy to external load 170.

### SUMMARY

This invention relates to polymer catalysts for photovoltaic cells, as well as related compositions, articles, and methods.

In one aspect, this invention features an article that includes a first layer having a surface and a second layer disposed on the surface of the first layer. The first layer includes an electrically conductive material. The second layer includes a cross-linked polymer. The cross-linked polymer includes a plurality of pairs of directly bonded cross-linked monomeric units and is capable of catalyzing reduction of I₃⁻ to I⁻.

In another aspect, this invention features an article identical to the article mentioned above except that the second layer includes a monomer capable of forming a cross-linked polymer in the absence of a cross-linking agent. The cross-linked polymer is capable of catalyzing reduction of I₃⁻ to I⁻.

In still another aspect, this invention features a method that includes forming a first layer on a surface, the first layer comprising a monomer capable of forming a cross-linked polymer in the absence of a cross-linking agent. The method also includes forming the cross-linked polymer by cross-linking at least some of the plurality of monomer molecules to form a plurality of pairs of directly bonded cross-linked monomeric units. The cross-linked polymer is capable of catalyzing reduction of I₃⁻ to I⁻.

In still another aspect, this invention features a composition that includes a monomer capable of forming a cross-linked polymer in the absence of a cross-linking agent, a solvent, and an acid. The cross-linked polymer is capable of catalyzing reduction of I₃⁻ to I⁻.

In a further aspect, this invention features a photovoltaic cell. The photovoltaic cell includes a first electrode, a second electrode that includes an electrically conductive layer having a surface and a second layer disposed on the surface of the electrically conductive layer, and a third layer including I₃⁻/I⁻ disposed between the first electrode and the second electrode. The second layer includes a cross-linked polymer that contains a plurality of pairs of directly linked cross-linked monomeric units and is capable of catalyzing reduction of I₃⁻ to I⁻.

Other features and advantages of the invention will be apparent from the description, drawings and claims.

### DESCRIPTION OF DRAWINGS

FIG. 1 is a cross-sectional view of an embodiment of a photovoltaic cell.

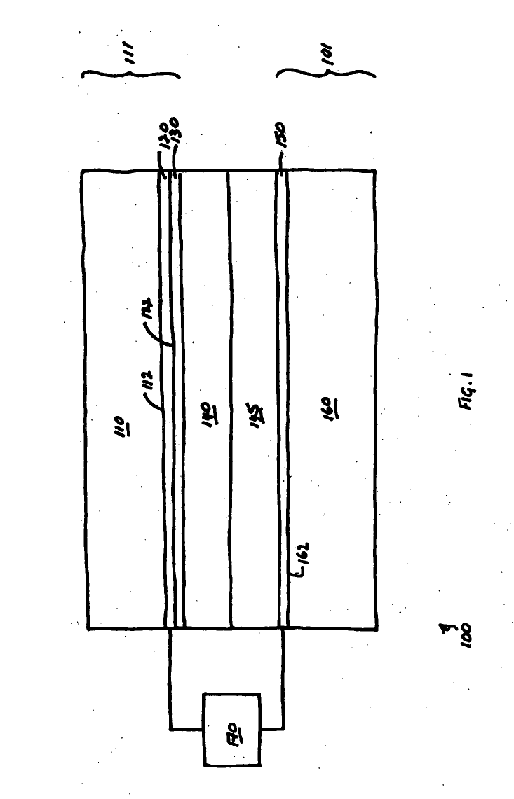

FIG. 2 is a cross-sectional view of another embodiment of a photovoltaic cell.

FIG. 3 is a cross-sectional view of an embodiment of a photovoltaic cell including a mesh electrode.

Like reference symbols in the various drawings indicate like elements.

### DETAILED DESCRIPTION

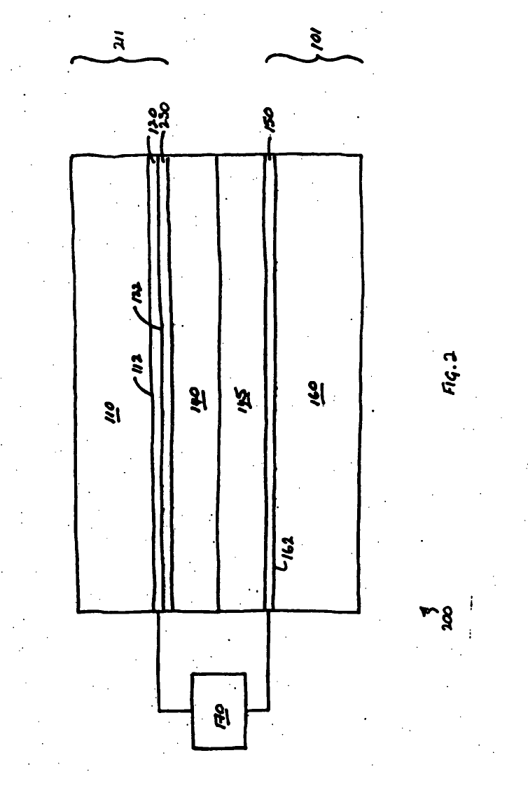

Referring to FIG. 2, a counter electrode 211 of a DSSC 200 includes a catalyst layer 230 having a polymer catalyst. The type of polymer generally depends on the redox system in charge carrier layer 140, and polymer catalysts are typically selected based on their ability to catalyze the redox reaction in charge carrier layer 140. Polymer catalysts can also be selected based on criteria such as, for example, their compatibility with manufacturing processes, long term stability, and optical properties.

One example of an electrolyte redox system contained in layer 140 is I₃⁻/I⁻, which can be provided as a solution of an iodide salt (e.g., lithium iodide) and iodine. An example of such a solution is 0.5 molar (“M”) tertiary-butyl pyridine, 0.1 M lithium iodide, 0.05 M 12, and 0.6 M butylmethyl imidazolium iodide in acetonitrile/valeronitrile (1/1, v/v).

Polymers capable of catalyzing reduction of I₃⁻ to I⁻ include polythiophenes polypyrrole, polyaniline, and their derivatives. Examples of polythiophene derivatives include poly(3,4-ethylenedioxythiophene) (“PEDOT”), poly(3-butylthiophene), poly[3-(4-octylphenyl)thiophene], poly(thieno[3,4-b]thiophene) (“PT34bT”), and poly(thieno[3,4-b]thiophene-co-3,4-ethylenedioxythiophene) (“PT34bT-PEDOT”).

In certain embodiments, the polymer can be cross-linked. For example, the cross-linked polymer can be obtained from a monomer that is capable of forming a cross-linked polymer in the absence of a cross-linking agent. Scheme 1 below illustrates a general synthetic route of preparing such a cross-linked polymer: 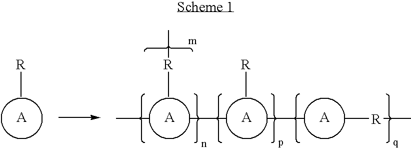
In Scheme 1, ring A is an aromatic ring, R is a reactive group covalently associated with ring A, and each of m, n, p, and q is at least about five (e.g., at least about 10, at least about 50, at least about 100, at least about 250, or at least about 500) and/or at most about 10,000 (e.g., at most about 5,000 or at most about 1,000). Examples of ring A include a thiophene ring, a furan ring, a pyrrole ring, and a benzene ring. The reactive group R can be either a substituent on ring A or a ring (e.g., an aromatic ring) fused with ring A. The reactive group R can also contain a thiophene ring, a furan ring, a pyrrole ring, or a benzene ring. Examples of reactive groups include thiophene moieties, benzothiophene moieties, and naphthothiophene moieties. Both ring A and reactive group R can be substituted or unsubstituted. Examples of substituents include alkyl, alkenyl, alkynyl, cycloalkyl, cycloalkenyl, fluorocarbon, alkoxy, aryl, aryloxy, heteroaryl, heteroaryloxy, amino, alkylamino, dialkylamino, arylamino, diarylamino, hydroxyl, halogen, thio, alkylthio, arylthio, cyano, nitro, acyl, acyloxy, carboxyl, and carboxylic ester. Without wishing to be bound by any theory, it is believed that it is advantageous for the reactive groups to have similar reactivity to the first ring when the monomer is polymerized.

During polymerization, ring A on a monomer molecule covalently bonds with two other monomer molecules. The reactive group R on the monomer molecule can covalently bond with either ring A or reactive group R on a third monomer molecule (e.g., in another polymer chain) in the absence of a cross-linking agent, thereby forming a pair of directly bonded cross-linked monomeric units. The cross-linked polymer thus obtained contains a plurality of pairs of directly bonded cross-linked monomeric units. In some embodiments, essentially all of the cross-linked monomeric units are directly bonded.

Scheme 2 below illustrates an example of synthesizing, in the absence of a cross-linking agent, a cross-linked polymer capable of catalyzing reduction of I₃⁻ to I⁻. More specifically, thieno[3,4-b]thiophene is polymerized and cross-linked by using iron (III) tosylate as an oxidant initiator to form a cross-linked poly(thieno[3,4-b]thiophene). As shown in Scheme 2, the cross-linked monomeric units in the cross-linked polymer are bonded to each other directly.

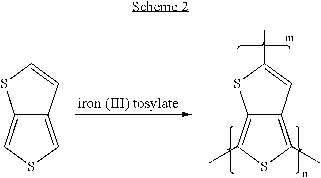

Scheme 3 below illustrates an example of preparing a cross-linked PT34bT-PEDOT copolymer. Specifically, T34bT and EDOT are polymerized and cross-linked by using iron (III) tosylate as an oxidant initiator. During polymerization, a EDOT moiety can be covalently bonded to either one of the two thiophene rings in a T34bT moiety. A EDOT moiety can also be covalently bonded to another EDOT moiety. Similarly, a T34bT moiety can also be covalently bonded to either a EDOT moiety or either one of the two thiophene rings on another T34bT moiety. In some embodiments, the molar percent (i.e., x) of the EDOT moieties in the copolymer is at least about 10% (e.g., at least about 20%, at least about 30%, at least about 40%, at least about 50%, at least about 60%, at least about 70%, at least about 80%, or at least about 90%). In this reaction, PEDOT functions as a co-monomer.

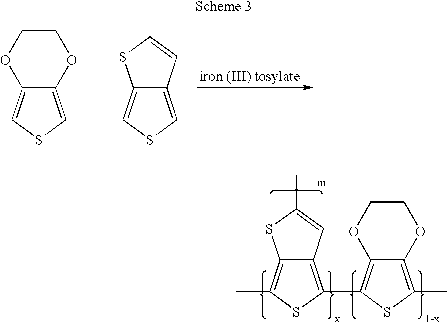

In some embodiments, the monomers mentioned above can also be polymerized and cross-linked in the presence of a cross-linking agent, such as a di-functional compound (e.g., a di-functional thiophene compound). In such embodiments, not all of the monomeric units are directly bonded to each other. Instead, at least some of the monomeric units are bonded to each other via cross-link agent moieties. For example, during polymerization, two reactive groups on two monomeric units of two polymer chains can be covalently bonded with a cross-linking agent molecule, thereby forming two cross-linked monomeric units. The two cross-linked monomeric units thus obtained are bonded to each other via a cross-linking agent moiety and therefore are not directly bonded.

In general, catalyst layer 230 adheres well to surface 122 of layer 120. The adhesion between catalyst layer 230 and surface 122 can be sufficiently strong to withstand various processing steps and environmental factors the DSSC experiences during manufacture and use. One example of a process step is washing (described below). In general, the adhesion between catalyst layer 230 and surface 122 prevents catalyst layer 120 from delaminating from surface 122 during the washing process. Generally, the adhesion also prevents catalyst layer 230 from delaminating during subsequent coating steps and during lamination of the DSSC substrates (described below). In some embodiments, catalyst layer 230 exhibits good adhesion under conditions of high temperature (e.g., up to about 85° C.) and/or when exposed to relatively harsh chemical conditions (e.g., I₃⁻/I⁻ dissolved in an organic solvent or ionic liquid).

In some embodiments, adhesion between catalyst layer 230 and surface 122 is greater than adhesion between electrically conductive layer 120 and surface 112. For example, in such embodiments, a manual peel test performed on catalyst layer 230 will cause the electrically conductive layer 120 to delaminate from substrate surface 112, rather than catalyst layer 230 to delaminate from surface 122. One example of a manual peel test is to use a knife to make a cut in the coating film and attempt to peel or scratch the coating film from the substrate.

In general, the thickness of catalyst layer 230 can vary as desired. In some embodiments, catalyst layer can be relatively thin compared to the substrate 110, which can have a thickness of microns, tens of microns, or hundreds of microns. For example, catalyst layer 230 can have a thickness of less than about one micron (e.g., less than about 500 nm). In some embodiments, catalyst layer 230 has a thickness of less than about 100 nm (e.g., less than about 50 nm or less than about 30 μm).

Catalyst layer 230 is generally transparent. Typically, layer 230 is sufficient thin to be transparent, but also thick enough to adequately act as a catalyst layer in a photovoltaic cell. As referred to herein, a transparent layer transmits at least about 60% (e.g., at least about 70%, at least about 75%, at least about 80%, or at least about 85%) of incident energy at a wavelength or a range of wavelengths used during operation of the DSSC. Typically, the wavelength range of operation is within the solar spectrum (e.g., between about 380 nm and about 900 nm). In some embodiments, the wavelength range is within the range of visible light (e.g., from about 380 nm and to 700 nm).

In some embodiments, catalyst layer 230 can transmit more incident energy at a given optical wavelength or a given range of optical wavelengths than a platinum catalyst layer that would provide a comparable level of catalysis in charge carrier layer 140.

Catalyst layer 230 can include other compounds in addition to the polymer catalyst (e.g., in addition to PEDOT or PT34bT), such as, for example, compounds that affect the mechanical, optical, and/or other physical properties of layer 230. As an example, in some embodiments, catalyst layer 230 can include a compound that changes the refractive index of the polymer catalyst (e.g., to reduce a refractive index mismatch between polymer catalyst layer 230 and electrically conductive layer 120 and/or charge carrier layer 140). As another example, in certain embodiments, catalyst layer 230 can include a compound, such as a cross-linker, that changes the mechanical properties of the polymer catalyst (e.g., to increase the rigidity of polymer catalyst layer 230).

Catalyst layer 230 can be applied to surface 122 using a variety of techniques.

In some embodiments, the polymer can be electrochemically deposited or coated on surface 122. During electrochemical deposition, substrate 110 can be placed in a bath containing a solution of a monomer and applying a voltage between electrically conductive layer 120 and another electrode. In some embodiments, the solution can include an acid. Methods of electrochemical deposition are described in, for example, “Fundamentals of Electrochemical Deposition,” by Milan Paunovic and Mordechay Schlesinger (Wiley-Interscience; November 1998).

In certain embodiments, the polymer can be applied using a coating method, such as ink jet printing, spin coating, dip coating, knife coating, bar coating, spray coating, roller coating, slot coating, gravure coating, screen printing, and/or ink-jetting. Coating methods can be used in both continuous and batch modes of manufacturing. In some embodiments, a polymer catalyst is coated as a hot melt.

In certain embodiments, a polymer is coated as a monomer (e.g., ethylene-dioxythiophene (EDOT) or thieno[3,4-b]thiophene) which is subsequently polymerized. In some embodiments, the monomer is capable of forming a cross-linked polymer in the absence of a cross-linking agent. In some embodiments, the monomer is a mixture, for example, including a monomer capable of forming a cross-linked polymer in the absence of a cross-linking agent and a monomer requiring a cross-linking agent to form a cross-linked polymer. The weight percentage of the monomer capable of forming a cross-linked polymer in the absence of a cross-linking agent can be at least about 5% (e.g., at least about 10%, at least about 20%, at least about 50%, at least about 80%, or about 100%). In some embodiments, the monomer is coated in solution onto surface 122 and subsequently polymerized to form polymer catalyst layer 230. In addition to the monomer and a suitable solvent, such solutions typically include an acid and an initiator for initiating polymerization of the monomer.

The weight percentage of the monomer in the solvent can vary depending on, for example, the coating method, the type of solvent, and the conditions under which surface 122 is coated (e.g., web velocity). For example, for a given web velocity, the percentage of monomer in the solution can be increased if a thicker catalyst layer is desired. In some embodiments, the solution can contain less than about five percent (e.g., less than about three percent or less than about one percent) by weight of the monomer.

A suitable solvent is a solvent capable of dissolving the monomer and initiator, and compatible with the acid (the acid and solvent should be miscible and should not react with each other). Suitable solvents for thiophene monomers, for example, include many polar organic and inorganic solvents (the solvent molecules possess a permanent dipole moment). Examples of polar organic solvents include alcohols (e.g., methanol, ethanol, or i-propanol), sulphoxides (e.g., dimethyl sulphoxide), sulphones (e.g., sulfolane), halogenated alkanes (e.g., dichloromethane or dichloroethane), amides (e.g., methyl acetamide or dimethyl formamide) and nitrites (e.g., acetonitrile). An example of a polar inorganic solvent is water.

Without wishing to be bound by theory, it is believed that the acid can provide improved adhesion between the catalyst layer 230 and surface 122. Suitable acids include organic acids and inorganic acids. Examples of inorganic acids include hydrochloric acid, nitric acid, perchloric acid, chloric acid, hydrogen iodide, hydrogen bromide, or thiocyanic acid. Examples of organic acids may include trifluoromethanesulfonic acid, benzenesulfonic acid, methanesulphonic acid, p-toluenesulfonic acid, or tricyanomethane.

In some embodiments, the acid can have a low pKa. For example, the acid can have a pKa less than about 3 (e.g., less than about 2, less than about 1, less than about zero, less than about −1, less than about −2, or less than about −3).

Without wishing to be bound by theory, it is believed that the concentration of the acid should be sufficient to improve adhesion between the polymer and surface 122 during the time surface 122 is exposed to the acid. In addition to the type of acid and material forming electrically conducting layer 120, the acid concentration can depend on various manufacturing process parameters, such as percent solids in the monomer solution, desired dry thickness of the coating, web speed, and drying temperature. In some embodiments, the acid has a concentration of between about 0.01 M and about 0.4 M (e.g., at least about 0.05 M, at least about 0.1 M, at most about 0.3 M, or at most about 0.2 M).

In some embodiments, no acid is included in the coating solution. In such embodiments, surface 122 can be pretreated with an acid (e.g., bathed in an acid or coated with an acid) prior to coating with the monomer solution.

Polymerization of the coated monomer can be initiated in a variety of ways, such as chemically, thermally, electrically (e.g., electrochemically, or via an electron beam). Combinations of techniques can be used. In embodiments where polymerization is initiated chemically, the solution can include an initiator, such as a photoinitiator or an oxidant. Examples of oxidants suitable for polymerizing thiophene monomers include iron (III) salts, such as FeCl₃, Fe(ClO₄)₃, and/or iron (III) salts of organic acids (e.g., iron (III) tosylate). In addition to iron (III) salts, suitable oxidant initiators for thiophene monomers include H₂O₂, K₂Cr₂O₇, alkali metal persulphates, ammonium persulphates, alkali metal perborates, potassium permanganate and/or copper salts.

In certain embodiments, an initiator can cause a monomer to react to form a cross-linked polymer in the absence of a cross-linking agent. For example, in the absence of a cross-linking agent, an oxidant initiator (e.g., iron (III) tosylate) can cause a monomer containing a thiophene ring and a reactive group covalently associated with the thiophene ring (e.g., thieno[3,4-b]thiophene) to react to form a cross-linked polymer (e.g., poly(thieno[3,4-b]thiophene)). During the polymerization reaction, the initiator can cause the polymer to cross-link, for example, by covalently bonding the reactive group on one monomeric unit on one polymer chain directly to another monomeric unit on another polymer chain. The cross-linked polymer thus obtained does not contain initiator moieties in the polymer chain.

The relative amount of initiator in the solvent can vary depending on the amount of monomer and the desired degree of polymerization. A high concentration of initiator can result in a higher molecular weight of the resulting polymer. In some embodiments, the ratio of the molar concentration of the monomer to the molar concentration of the initiator in the composition is equal to or less than about five (e.g., from about 0.5 to about five, from about 0.5 to about two, or from about 0.5 to about one).

In some embodiments, thiophene monomers, for example, are polymerized by heating in the presence of an oxidant. The polymerization temperature can vary, but should be below temperatures that would damage the substrate and/or polymer catalyst. In some embodiments, the coating is heated to a temperature of from about 50° C. to about 300° C., such as from about 75° C. to about 150° C. (e.g., about 120° C.).

Generally, after polymerization, the coating is washed. Washing typically involves rinsing the polymer layer with a solvent (e.g., an alcohol, water, or a combination of alcohol and water). The solvent may dissolve certain undesirable components from the coating (e.g., unreacted monomer and residual initiator) to substantially remove undesirable components from the polymer layer. Washing can include agitating (e.g., ultrasonically agitating) the layer to help flush these components. In embodiments where the polymer catalyst is coated in a continuous process, washing can involve running the coated web through a solvent bath or series of baths.

In some embodiments (e.g., with or without the use of an acid), surface 122 can be treated with other compounds to promote adhesion. For example, prior to applying the polymer catalyst, surface 122 can be coated with a cross-linking agent (e.g., a bifunctional silane or epoxy) that bonds to surface 122 and to the subsequently applied polymer.

Turning now to other components of DSSC 200, the composition and thickness of electrically conductive layer 120 is generally selected based on desired electrical conductivity, optical properties, and/or mechanical properties of the layer. In some embodiments, layer 120 is transparent. Examples of transparent materials suitable for forming such a layer include certain metal oxides, such as indium tin oxide (ITO), tin oxide, and a fluorine-doped tin oxide. Electrically conductive layer 120 may be, for example, between about 100 nm and 500 nm thick, (e.g., between about 150 nm and 300 nm thick).

In embodiments where the acid in the solution is used to apply the polymer catalyst to surface 122, surface 122 can be a roughened surface. In other words, the microscopic surface area of, e.g., a 1 cm by 1 cm portion of surface 122 is greater than a 1 cm by 1 cm portion of a non-roughened surface (e.g., more than about five percent greater, such as about 10 percent or more). The additional microscopic surface area can be provided by topographical features on the order of sub-microns to tens of microns in size formed as materials are etched from layer 120 while it is in contact with the acid. Without wishing to be bound by theory, it is believed that roughening of surface 122 can enhance its adhesion to catalyst layer 230 because surface 122 presents a greater surface area with which the polymer in catalyst layer 230 can bond.

In embodiments where counter electrode 211 is not transparent, electrically conductive layer 120 can be opaque (i.e., can transmit less than about 10% of the visible spectrum energy incident thereon). For example, layer 120 can be formed from a continuous layer of an opaque metal, such as copper, aluminum, indium, or gold.

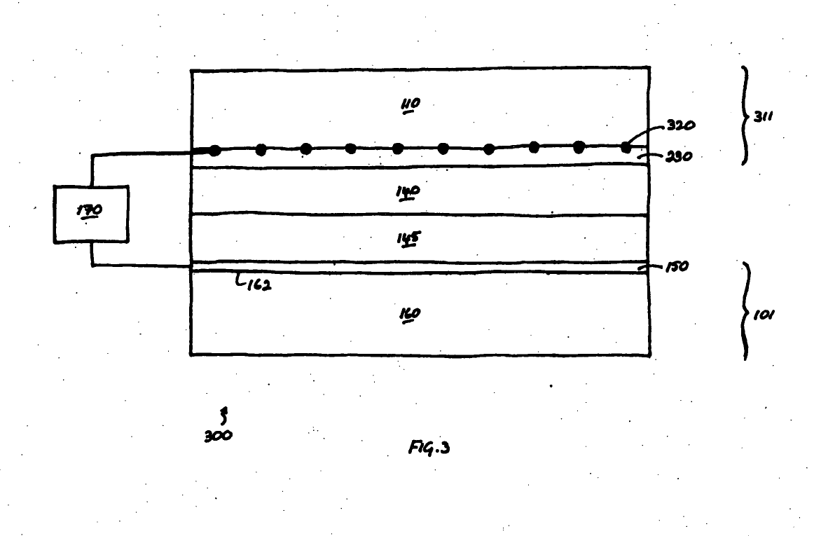

In some embodiments, electrically conductive layer 120 can include a discontinuous layer of a conductive material. For example, electrically conductive layer 120 can include an electrically conducting mesh. Referring to FIG. 3, a counter electrode 311 of a DSSC 300 includes a mesh electrode 320. Suitable mesh materials include metals, such as palladium, titanium, platinum, stainless steels and alloys thereof. In some embodiments, the mesh material includes a metal wire. The electrically conductive mesh material can also include an electrically insulating material that has been coated with an electrically conducting material, such as a metal. The electrically insulating material can include a fiber, such as a textile fiber or optical fiber. Examples of fibers include synthetic polymeric fibers (e.g., nylons) and natural fibers (e.g., flax, cotton, wool, and silk). The mesh electrode can be flexible to facilitate, for example, formation of the DSSC by a continuous manufacturing process. Photovoltaic cells having mesh electrodes are disclosed, for example, in co-pending U.S. Patent Application Publication No. 2003/0230337, U.S. Patent Application Publication No. 2004/0187911, and International Patent Application Publication Number WO 03/04117, each of which is hereby incorporated by reference.

The mesh electrode may take a wide variety of forms with respect to, for example, wire (or fiber) diameters and mesh densities (i.e., the number of wires (or fibers) per unit area of the mesh). The mesh can be, for example, regular or irregular, with any number of opening shapes. Mesh form factors (such as, e.g., wire diameter and mesh density) can be chosen, for example, based on the conductivity of the wire (or fibers) of the mesh, the desired optical transmissivity, flexibility, and/or mechanical strength. Typically, the mesh electrode includes a wire (or fiber) mesh with an average wire (or fiber) diameter in the range from about one micron to about 400 microns, and an average open area between wires (or fibers) in the range from about 60% to about 95%.

Referring to both FIG. 2 and FIG. 3, substrate 110 can be formed from a mechanically-flexible material, such as a flexible polymer, or a rigid material, such as a glass. Examples of polymers that can be used to form a flexible substrate include polyethylene naphthalates (PEN), polyethylene terephthalates (PET), polyethyelenes, polypropylenes, polyamides, polymethylmethacrylate, polycarbonate, and/or polyurethanes. Flexible substrates can facilitate continuous manufacturing processes such as web-based coating and lamination.

The thickness of substrate 110 can vary as desired. Typically, substrate thickness and type are selected to provide mechanical support sufficient for the DSSC to withstand the rigors of manufacturing, deployment, and use. Substrate 110 can have a thickness of from about six microns to about 5,000 microns (e.g., from about 6 microns to about 50 microns, from about 50 microns to about 5,000 microns, from about 100 microns to about 1,000 microns).

In embodiments where the counter electrode is transparent, substrate 110 is formed from a transparent material. For example, substrate 110 can be formed from a transparent glass or polymer, such as a silica-based glass or a polymer, such as those listed above. In such embodiments, electrically conductive layer 120 should also be transparent.

Substrate 160 and electrically conductive layer 150 can be similar to substrate 110 and electrically conductive layer 120, respectively. For example, substrate 160 can be formed from the same materials and can have the same thickness as substrate 110. In some embodiments however, it may be desirable for substrate 160 to be different from 110 in one or more aspects. For example, where the DSSC is manufactured using a process that places different stresses on the different substrates, it may be desirable for substrate 160 to be more or less mechanically robust than substrate 110. Accordingly, substrate 160 may be formed from a different material, or may have a different thickness that substrate 110. Furthermore, in embodiments where only one substrate is exposed to an illumination source during use, it is not necessary for both substrates and/or electrically conducting layers to be transparent. Accordingly, one of substrates and/or corresponding electrically conducting layer can be opaque.

As discussed previously, charge carrier layer 140 includes a material that facilitates the transfer of electrical charge from a ground potential or a current source to photosensitized layer 145. A general class of suitable charge carrier materials include solvent-based liquid electrolytes, polyelectrolytes, polymeric electrolytes, solid electrolytes, n-type and p-type transporting materials (e.g., conducting polymers) and gel electrolytes. Other choices for charge carrier media are possible. For example, the charge carrier layer can include a lithium salt that has the formula LiX, where X is an iodide, bromide, chloride, perchlorate, thiocyanate, trifluoromethyl sulfonate, or hexafluorophosphate.

The charge carrier media typically includes a redox system. Suitable redox systems may include organic and/or inorganic redox systems. Examples of such systems include cerium(III) sulphate/cerium(IV), sodium bromide/bromine, lithium iodide/iodine, Fe²⁺/Fe³⁺, Co²⁺/Co³⁺, and viologens. Furthermore, an electrolyte solution may have the formula MᵢXⱼ, where i and j are greater than or equal to one, where X is an anion, and M is lithium, copper, barium, zinc, nickel, a lanthanide, cobalt, calcium, aluminum, or magnesium. Suitable anions include chloride, perchlorate, thiocyanate, trifluoromethyl sulfonate, and hexafluorophosphate.

In some embodiments, the charge carrier media includes a polymeric electrolyte. For example, the polymeric electrolyte can include poly(vinyl imidazolium halide) and lithium iodide and/or polyvinyl pyridinium salts. In embodiments, the charge carrier media can include a solid electrolyte, such as lithium iodide, pyridimum iodide, and/or substituted imidazolium iodide.

The charge carrier media can include various types of polymeric polyelectrolytes. For example, suitable polyelectrolytes can include between about 5% and about 95% (e.g., 5-60%, 5-40%, or 5-20%) by weight of a polymer, e.g., an ion-conducting polymer, and about 5% to about 95% (e.g., about 35-95%, 60-95%, or 80-95%) by weight of a plasticizer, about 0.05 M to about 10 M of a redox electrolyte of organic or inorganic iodides (e.g., about 0.05-2 M, 0.05-1 M, or 0.05-0.5 M), and about 0.01 M to about 1 M (e.g., about 0.05-0.5 M, 0.05-0.2 M, or 0.05-0.1 M) of iodine. The ion-conducting polymer may include, for example, polyethylene oxide (PEO), polyacrylonitrile (PAN), polymethylmethacrylate (PMMA), polyethers, and polyphenols. Examples of suitable plasticizers include ethyl carbonate, propylene carbonate, mixtures of carbonates, organic phosphates, butyrolactone, and dialkylphthalates.

As discussed previously, photosensitized layer 145 includes a semiconductor material and a photosensitizing agent. These component materials can be in the form of a photosensitized nanoparticle material Suitable nanoparticles include nanoparticles of the formula MₓO_{y} where M may be, for example, titanium, zirconium, tungsten, niobium, lanthanum, tantalum, terbium, or tin and x and y are integers greater than zero. Other suitable nanoparticle materials include sulfides, selenides, tellurides, and oxides of titanium, zirconium, tungsten, niobium, lanthanum, tantalum, terbium, tin, or combinations thereof. For example, TiO₂, SrTiO₃, CaTiO₃, ZrO₂, WO₃, La₂O₃, Nb₂O₅, SnO₂, sodium titanate, cadmium selenide (CdSe), cadmium sulphides, and potassium niobate may be suitable nanoparticle materials. In various embodiments, photosensitized layer 145 includes nanoparticles with an average size between about 2 nm and about 100 nm (e.g., between about 10 nm and about 40 nm, such as about 20 nm).

The nanoparticles can be interconnected, for example, by high temperature sintering (e.g., more than about 400° C.), or by a reactive polymeric linking agent, such as poly(n-butyl titanate). A polymeric linking agent can enable the fabrication of an interconnected nanoparticle layer at relatively low temperatures (e.g., less than about 300° C.) and in some embodiments at room temperature. The relatively low temperature interconnection process may be amenable to continuous manufacturing processes using polymer substrates.

The interconnected nanoparticles are photosensitized by a photosensitizing agent. The photosensitizing agent facilitates conversion of incident light into electricity to produce the desired photovoltaic effect. It is believed that the photosensitizing agent absorbs incident light resulting in the excitation of electrons in the photosensitizing agent. The energy of the excited electrons is then transferred from the excitation levels of the photosensitizing agent into a conduction band of the interconnected nanoparticles. This electron transfer results in an effective separation of charge and the desired photovoltaic effect. Accordingly, the electrons in the conduction band of the interconnected nanoparticles are made available to drive external load 170.

The photosensitizing agent can be sorbed (e.g., chemisorbed and/or physisorbed) on the nanoparticles. The photosensitizing agent is selected, for example, based on its ability to absorb photons in a wavelength range of operation (e.g., within the visible spectrum), its ability to produce free electrons (or electron holes) in a conduction band of the nanoparticles, and its effectiveness in complexing with or sorbing to the nanoparticles. Suitable photosensitizing agents may include, for example, dyes that include functional groups, such as carboxyl and/or hydroxyl groups, that can chelate to the nanoparticles, e.g., to Ti(IV) sites on a TiO₂ surface. Exemplary dyes include anthocyanines, porphyrins, phthalocyanines, merocyanines, cyanines, squarates, eosins, and metal-containing dyes such as cis-bis(isothiocyanato)bis(2,2′-bipyridyl-4,4′-dicarboxylato)-ruthenium (II) (“N3 dye”), tris(isothiocyanato)-ruthenium (II)-2,2′:6′,2″-terpyridine-4,4′,4″-tricarboxylic acid, cis-bis(isothiocyanato)bis(2,2′-bipyridyl-4,4′-dicarboxylato) ruthenium (II) bis-tetrabutylammonium, cis-bis(isocyanato) (2,2′-bipyridyl-4,4′-dicarboxylato) ruthenium (II), and tris(2,2′-bipyridyl-4,4′-dicarboxylato) ruthenium (II) dichloride, all of which are available from Solaronix.

Although, in the foregoing embodiments, the semiconductor material and electrolyte are in different layers, in some embodiments these materials may be interspersed in a composite layer.

In general, it is desirable to have good adhesion between catalyst layer 230 and surface 122. For example, the redox electrolyte solution can be corrosive to layer 230, which can result in delamination of layer 230 from surface 122 in the absence of good adhesion.

In certain embodiments, adhesion between layer 230 and surface 122 passed the tape test. As referred to herein, the tape test is conducted as follows. Layer 230 is adhered to surface 122. Tape (Magic tape, 3M) is then firmly applied to the surface of layer 230 that is opposite the surface of layer 230 that faces surface 122, and the tape is rapidly peeled off. Adhesion between layer 230 and surface 122 passes the tape test if layer 230 is not removed from surface 122 when the tape is peeled off.

In some embodiments, adhesion between layer 230 and surface 122 passed the wipe test. As referred to herein, the wipe test is conducted as follows. Layer 230 is adhered to surface 122. A tissue (Kimwipe, Kimberly-Clark) is pushed hard on the surface of layer 230 that is opposite the surface of layer 230 that faces surface 122, and the tissue is moved laterally five times while continuing to push hard. Adhesion between layer 230 and surface 122 passes the wipe test if layer 230 is not removed from surface 122 subsequent to the five lateral movements.

In certain embodiments, DSSC 200 made with an electrode containing PEDOT or PT34bT catalyst layer which was aged in electrolyte solution at 85° C. for at least about 100 hours (e.g., at least about 200 hours, at least about 300 hours, at least about 400 hours) can provide the same output current as an otherwise identical DSSC made from a fresh polymer catalyst layer contained electrode (e.g., the output current can vary less than about 10%).

In some embodiments, DSSC 200 can provide consistent long-term stability (e.g., the output current can vary less than about 10%) under constant ageing of cell at 65° C. for periods of 80 hours or more.

DSSC's can provide relatively efficient conversion of incident light into electrical energy. For example, DSSC's may exhibit efficiencies more than about one percent (e.g., more than about two percent, three percent, four percent, five percent, eight percent, such as ten percent or more) as measured under the sun at AM 1.5 global irradiation.

The following examples are illustrative and not intended to be limiting.

### EXAMPLE 1

0.04 gram of EDOT (Baytron M, Bayer), 1.0 gram of Baytron CB-40 (Bayer, 40 weight percent iron tosylate in 1-butanol) and 0.033 gram of 37 weight percent hydrochloric acid were dissolved in 3.0 grams of 1-butanol. The resulting solution was applied onto a 10 ohm/sq. ITO/PEN substrate and spin coated at 600 rpm for 110 seconds. The coated film was heated at 120° C. for 5 minutes and subsequently cooled. The resulting PEDOT film was then washed using methanol and then dried at 100° C.

### EXAMPLE 2

0.04 gram of thieno[3,4-b]thiophene (T34bT) (Air Products), 1.38 gram of Baytron CB-40 (Bayer, 40 weight percent iron tosylate in 1-butanol), and 0.055 gram of 37 weight percent hydrochloric acid were dissolved in 3.5 grams of 1-butanol. The solution was applied onto a 10 ohm/sq. ITO/PEN substrate and spin coated at 600 rpm for 110 seconds. The coated film was heated at 120° C. for 5 minutes and subsequently cooled. The resulting PT34bT film was then washed using methanol and then dried at A counter electrode prepared based on a PT34bT film showed comparable photovoltaic performance and cell stability to a counter electrode prepared based on a PEDOT film.

### EXAMPLE 3

0.034 gram of thieno[3,4-b]thiophene (T34bT) (Air Products), 0.034 gram of ethylene-dioxythiophene (EDOT) (Baytron M, Bayer), 2.0 gram of Baytron CB-40 (Bayer, 40 weight percent iron tosylate in 1-butanol), and 0.08 gram of 37 weight percent hydrochloric acid were dissolved in 5.0 grams of 1-butanol. The solution was applied onto a 10 ohm/sq. ITO/PEN substrate and spin coated at 600 rpm for 110 seconds. The coated film was heated at 120° C. for 5 minutes and subsequently cooled. The resulting PT34bT-PEDOT copolymer film was then washed using methanol and then dried at 100° C.

A counter electrode prepared based on a PT34bT-PEDOT copolymer film showed comparable photovoltaic performance and cell stability to a counter electrode prepared based on a PEDOT film.

Other embodiments are in the claims.

What is claimed is:

1. An article, comprising:
a first layer having a surface, the first layer comprising an electrically conductive material; and
a second layer disposed on the surface of the first layer, the second layer comprising a cross-linked polymer, the cross-linked polymer comprising a plurality of pairs of directly bonded cross-linked monomeric units and being capable of catalyzing reduction of I₃⁻ to I⁻.

2. The article of claim 1, wherein each cross-linked monomeric unit comprises a thiophene derivative.

3. The article of claim 2, wherein the cross-linked polymer is poly(thieno[3,4-b]thiophene).

4. The article of claim 2, wherein the cross-linked polymer is poly(thieno[3,4-b]thiophene-co-3,4-ethylenedioxythiophene).

5. The article of claim 1, wherein the electrically conductive material forms a transparent layer.

6. The article of claim 5, wherein the electrically conductive material comprises ITO, tin oxide, or fluorine-doped tin oxide.

7. The article of claim 6, wherein the first layer further comprises a conducting mesh.

8. The article of claim 1, wherein the article is an electrode.

9. The article of claim 7, wherein the article is a counter-electrode of a photovoltaic cell.

10. An article, comprising:
a first layer having a surface, the first layer comprising an electrically conductive material; and
a second layer disposed on the surface of the first layer, the second layer comprising a first monomer capable of forming a cross-linked polymer in the absence of a cross-linking agent, the cross-linked polymer being capable of catalyzing reduction of I₃⁻ to I⁻.

11. The article of claim 10, wherein the first monomer comprises a first ring and a reactive group covalently associated with the first ring.

12. The article of claim 11, wherein the first ring is a first thiophene ring.

13. The article of claim 12, wherein the reactive group comprises an aromatic group fused with the first thiophene ring.

14. The article of claim 13, wherein the reactive group comprises a second thiophene ring, a furan ring, a pyrrole ring, or a benzene ring.

15. The article of claim 14, wherein the reactive group comprises a thiophene moiety, a benzothiophene moiety, or a naphthothiophene moiety.

16. The article of claim 15, wherein the first monomer is thieno[3,4-b]thiophene.

17. The article of claim 10, wherein the second layer further comprises a second monomer.

18. The article of claim 17, wherein the second monomer is 3,4-ethylenedioxythiophene.

19. The article of claim 10, wherein the electrically conductive material forms a transparent layer.

20. The article of claim 19, wherein the electrically conductive material comprises ITO, tin oxide, or fluorine-doped tin oxide.

21. The article of claim 20, wherein the first layer further comprises a conducting mesh.

22. The article of claim 10, wherein the second layer further comprises an acid.

23. The article of claim 22, wherein the acid has a pKa of about three or less.

24. The article of claim 23, wherein the acid is hydrochloric acid, nitric acid, perchloric acid, chloric acid, hydrogen iodide, hydrogen bromide, thiocyanic acid, trifluoromethanesulfonic acid, benzenesulfonic acid, methanesulphonic acid, p-toluenesulfonic acid, or tricyanomethane.

25. The article of claim 24, wherein the second layer comprises at least about 0.01 molar of the acid.

26. The article of claim 10, wherein the second layer further comprises an initiator capable of causing the monomer to react to form the cross-linked polymer.

27. The article of claim 26, wherein the initiator is iron (III) tosylate.

28. A method, comprising:
forming a first layer on a surface, the first layer comprising a plurality of monomer molecules that are capable of forming a cross-linked polymer in the absence of a cross-linking agent; and
forming the cross-linked polymer by cross-linking at least some of the plurality of monomer molecules to form a plurality of pairs of directly bonded cross-linked monomeric units, the cross-linked polymer being capable of catalyzing reduction of I₃⁻ to I⁻.

29. The method of claim 28, wherein essentially all of the cross-linked monomeric units are pairs of directly bonded monomeric units.

30. The method of claim 28, wherein each cross-linked monomeric unit comprises a thiophene derivative.

31. The method of claim 30, wherein the cross-linked polymer is poly(thieno[3,4-b]thiophene).

32. The method of claim 30, wherein the cross-linked polymer is poly(thieno[3,4-b]thiophene-co-3,4-ethylenedioxythiophene).

33. The method of claim 28, further comprising disposing an electrically conducting material on the surface before forming the first layer.

34. The method of claim 33, wherein the electrically conductive material forms a transparent layer.

35. The method of claim 34, wherein the electrically conducting material comprises ITO, tin oxide, or fluorine-doped tin oxide.

36. The method of claim 35, further comprising disposing a conducting mesh on the surface before forming the first layer.

37. The method of claim 28, wherein the first layer further comprises an initiator capable of causing the monomer to react to form the cross-linked polymer.

38. The method of claim 37, wherein the initiator is iron (III) tosylate.

39. The method of claim 28, wherein the forming of the first layer comprises ink jet printing, spin coating, dip coating, knife coating, bar coating, spray coating, roller coating, slot coating, gravure coating, or screen printing.

40. The method of claim 28, wherein the first layer further comprises an acid.

41. The method of claim 40, further comprising washing the first layer after forming the cross-linked polymer; the first layer remaining adhered to the surface after washing.

42. A composition, comprising:
a first monomer capable of forming a cross-linked polymer in the absence of a cross-linking agent; the cross-linked polymer being capable of catalyzing reduction of I₃⁻ to I⁻.
a solvent; and
an acid.

43. The composition of claim 42, wherein the first monomer comprises a first ring and a reactive group covalently associated with the first ring.

44. The composition of claim 43, wherein the first ring is a first thiophene ring.

45. The composition of claim 44, wherein the reactive group comprises an aromatic group fused with the first thiophene ring.

46. The composition of claim 45, wherein the reactive group comprises a second thiophene ring, a furan ring, a pyrrole ring, or a benzene ring.

47. The composition of claim 46, wherein the reactive group is a thiophene moiety, a benzothiophene moiety, or a naphthothiophene moiety.

48. The composition of claim 47, wherein the first monomer is thieno[3,4-b]thiophene.

49. The composition of claim 42, further comprising a second monomer.

50. The composition of claim 49, wherein the second monomer is 3,4-ethylenedioxythiophene.

51. The composition of claim 42, wherein the solvent is water, an alcohol, a sulphoxide, a sulphone, an amide, or a nitrile.

52. The composition of claim 42, wherein the acid has a pKa of about three or less.

53. The composition of claim 52, wherein the acid is hydrochloric acid, nitric acid, perchloric acid, chloric acid, hydrogen iodide, hydrogen bromide, thiocyanic acid, trifluoromethanesulfonic acid, benzenesulfonic acid, methanesulphonic acid, p-toluenesulfonic acid, or tricyanomethane.

54. The composition of claim 53, wherein the composition comprises at least about 0.01 molar of the acid.

55. The composition of claim 42, further comprising an initiator capable of causing the monomer to react to form the cross-linked polymer.

56. The composition of claim 55, wherein the initiator is iron (III) tosylate.

57. A photovoltaic cell, comprising:
a first electrode;
a second electrode comprising an electrically conductive layer having a surface and a second layer disposed on the surface of the electrically conductive layer; the second layer comprising a cross-linked polymer, the cross-linked polymer comprising a plurality of pairs of directly linked cross-linked monomeric units and being capable of catalyzing reduction of I₃⁻ to I⁻; and
a third layer comprising I₃⁻/I⁻ disposed between the first electrode and the second electrode.

58. The photovoltaic cell of claim 57, wherein the cross-linked polymer is a polythiophene derivative.

59. The photovoltaic cell of claim 58, wherein the cross-linked polymer is poly(thieno[3,4-b]thiophene).

60. The photovoltaic cell of claim 58, wherein the cross-linked polymer is poly(thieno[3,4-b]thiophene-co-3,4-ethylenedioxythiophene).
